(19) United States
(12) Patent Application Publication
(10) Pub. No.: US 2024/0378428 A1
(43) Pub. Date: Nov. 14, 2024

(54) COMPUTING DEVICE, LEARNING CONTROL DEVICE, COMPUTING METHOD, LEARNING CONTROL METHOD, AND STORAGE MEDIUM

(71) Applicants: NEC CORPORATION, Tokyo (JP); THE UNIVERSITY OF TOKYO, Tokyo (JP)

(72) Inventors: Yusuke SAKEMI, Tokyo (JP); Timothee LEVI, Tokyo (JP); Kazuyuki AIHARA, Tokyo (JP)

(73) Assignees: NEC CORPORATION, Tokyo (JP); THE UNIVERSITY OF TOKYO, Tokyo (JP)

(21) Appl. No.: 18/686,746

(22) PCT Filed: Sep. 10, 2021
(86) PCT No.: PCT/JP2021/033336

§ 371 Date: Feb. 26, 2024

(51) Int. Cl. G06N 3/048; G06F 17/16; G06N 3/044

(52) U.S. Cl. CPC G06N 3/048; G06F 17/16; G06N 3/044

(57) ABSTRACT

A computing device calculates a product between an interconnectivity-representation matrix including a plurality of elements having values each set to 1, 0, or −1 and a vector representing values of intermediate nodes, carries out a shift operation with a bit string in binary notation for each element among a plurality of elements of a vector obtained by the product, makes summation of a vector obtained by the shift operation and a vector including weighted input values, applies a function, which is determined as an activation function, for each element among a plurality of elements of a vector obtained by the summation of the vector obtained by the shift operation and the vector having the weighted input values, thus calculating a vector representing the values of the intermediate nodes updated in timestep progression, and calculates a plurality of output values by weighting the updated values of the intermediate nodes.

### TECHNICAL FIELD

The present invention relates to a computing device, a learning control device, a computing method, a learning control method, and a storage medium.

### BACKGROUND ART

Reservoir computing (RC) is known as one example of information processing technology using neural networks (e.g. PTL 1).

The reservoir computing uses recurrent neural networks (RNN) as its neural network architecture, wherein subjects of learning are limited to weight factors for connecting output layers.

### CITATION LIST

### Patent Literature

PTL 1: U.S. Patent Application Publication No. 2018/0309266

### SUMMARY OF INVENTION

### Technical Problem

It is preferable to simplify calculations in machine-learning models having recurrent network architectures such as reservoir computing.

The present invention has an exemplary objective to provide a computing device, a learning control device, a computing method, a learning control method, and a storage medium, which can solve the aforementioned problem.

### Solution to Problem

In a first aspect of the present invention, a computing device includes a matrix-product calculating means configured to calculate a product between an interconnectivity-representation matrix including a plurality of elements having values each set to 1, 0, or −1 and a vector representing values of intermediate nodes, a shift operation means configured to carry out a shift operation with a bit string in binary notation for each element among a plurality of elements of a vector obtained by the product, a summation means configured to make summation of a vector obtained by the shift operation and a vector including weighted input values, an activation-function applying means configured to apply a function, which is determined as an activation function, for each element among a plurality of elements of a vector obtained by the summation of the vector obtained by the shift operation and the vector having the weighted input values, thus calculating a vector representing the values of the intermediate nodes updated in timestep progression, and an output-value calculating means configured to calculate a plurality of output values by weighting the updated values of the intermediate nodes.

In a second aspect of the present invention, a computing method causes a computing device to implement: calculating a product between an interconnectivity-representation matrix including a plurality of elements having values each set to 1, 0, or −1 and a vector representing values of intermediate nodes: carrying out a shift operation with a bit string in binary notation for each element among a plurality of elements of a vector obtained by the product: making summation of a vector obtained by the shift operation and a vector including weighted input values: applying a function, which is determined as an activation function, for each element among a plurality of elements of a vector obtained by the summation of the vector obtained by the shift operation and the vector having the weighted input values, thus calculating a vector representing the values of the intermediate nodes updated in timestep progression; and calculating a plurality of output values by weighting the updated values of the intermediate nodes.

In a third aspect of the present invention, a learning control method implements: in a computing device including a matrix-product calculating means configured to calculate a product between an interconnectivity-representation matrix including a plurality of elements having values each set to 1, 0, or −1 and a vector representing values of intermediate nodes, a shift operation means configured to carry out a shift operation with a bit string in binary notation for each element among a plurality of elements of a vector obtained by the product, a summation means configured to make summation of a vector obtained by the shift operation and a vector including weighted input values, an activation-function applying means configured to apply a function, which is determined as an activation function, for each element among a plurality of elements of a vector obtained by the summation of the vector obtained by the shift operation and the vector having the weighted input values and to thereby calculate a vector representing the values of the intermediate nodes updated in timestep progression, and an output-value calculating means configured to calculate a plurality of output values by weighting the updated values of the intermediate nodes, setting a plurality of elements of the interconnectivity-representation matrix of the computing device such that each element has a value which becomes zero with a predetermined probability; and controlling the computing device having a setting of elements of the interconnectivity-representation matrix to make learning, thus updating weight factors used for calculating a plurality of output values.

In a fourth aspect of the present invention, a storage medium is configured to store a program causing a device operable according to the program to implement: calculating a product between an interconnectivity-representation matrix including a plurality of elements having values each set to 1, 0, or −1 and a vector representing values of intermediate nodes; carrying out a shift operation with a bit string in binary notation for each element among a plurality of elements of a vector obtained by the product: making summation of a vector obtained by the shift operation and a vector including weighted input values: applying a function, which is determined as an activation function, for each element among a plurality of elements of a vector obtained by the summation of the vector obtained by the shift operation and the vector having the weighted input values, thus calculating a vector representing the values of the intermediate nodes updated in timestep progression; and calculating a plurality of output values by weighting the updated values of the intermediate nodes.

In a fifth aspect of the present invention, a storage medium is configured to store a program causing a computer to implement: in a computing device including a matrix-product calculating means configured to calculate a product between an interconnectivity-representation matrix including a plurality of elements having values each set to 1, 0, or −1 and a vector representing values of intermediate nodes, a shift operation means configured to carry out a shift operation with a bit string in binary notation for each element among a plurality of elements of a vector obtained by the product, a summation means configured to make summation of a vector obtained by the shift operation and a vector including weighted input values, an activation-function applying means configured to apply a function, which is determined as an activation function, for each element among a plurality of elements of a vector obtained by the summation of the vector obtained by the shift operation and the vector having the weighted input values and to thereby calculate a vector representing the values of the intermediate nodes updated in timestep progression, and an output-value calculating means configured to calculate a plurality of output values by weighting the updated values of the intermediate nodes, setting a plurality of elements of the interconnectivity-representation matrix of the computing device such that each element has a value which becomes zero with a predetermined probability; and controlling the computing device having a setting of elements of the interconnectivity-representation matrix to make learning, thus updating weight factors used for calculating a plurality of output values.

### Advantageous Effects of Invention

According to the present invention, it is possible to relatively simplify calculations of computing models having recurrent network architectures.

### BRIEF DESCRIPTION OF DRAWINGS

FIG. 1 A block diagram showing a device configuration example of a computing system according to the exemplary embodiment.

FIG. 2 A block diagram showing a configuration example of a computing device according to the exemplary embodiment.

FIG. 3 A block diagram showing a configuration example of a learning control device according to the exemplary embodiment.

FIG. 4 A graph showing a first example of the relationship between a spectral radius and a sparsity of a machine-learning model in the computing system according to the exemplary embodiment.

FIG. 5 A graph showing a second example of the relationship between the spectral radius and the sparsity of a machine-learning model in the computing device according to the exemplary embodiment.

FIG. 6 A flowchart showing an example of a procedure of the learning control device according to the exemplary embodiment.

FIG. 7 A table showing an example of the relationship between a sparsity and an estimation accuracy of the computing device according to the exemplary embodiment.

FIG. 8 A block diagram showing another configuration example of the computing device according to the exemplary embodiment.

FIG. 9 A block diagram showing another configuration example of the learning control device according to the exemplary embodiment.

FIG. 10 A flowchart showing an example of a procedure according to a computing method of the exemplary embodiment.

FIG. 11 A flowchart showing an example of a procedure according to a learning control method of the exemplary embodiment.

FIG. 12 A block diagram diagrammatically showing a computer configuration according to at least one embodiment.

### DESCRIPTION OF EMBODIMENTS

Hereinafter, the exemplary embodiment of the present invention will be described, but the exemplary embodiment described below should not limit the scope of the invention as defined in the appended claims. In addition, all the combinations of features described in the exemplary embodiment should not necessarily be essential to the technical solution of the present invention.

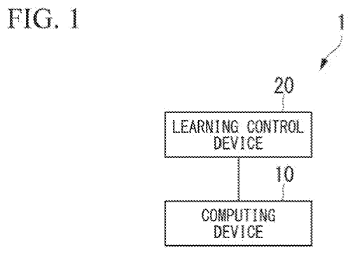

FIG. 1 is a block diagram showing a device configuration example of a computing system according to the exemplary embodiment. According to the configuration shown in FIG. 1, a computing system 1 includes a computing device 10 and a learning control device 20.

The computing device 10 is configured to carry out calculations using machine-learning models having recurrent network architectures. Herein, it is unnecessary to explicitly demonstrate recurrent network architectures. For example, the computing device 10 may be configured of hardware having signal lines which can be wired in various shaping including loops, however, the configuration method of the computing device 10 should not be limited to a specific method.

Hereinafter, an example will be described with respect to machine-learning models having recurrent network architectures which can be expressed by computational expressions using determinants.

In this connection, machine-learning models having recurrent network architectures used for the computing device 10 will be simply referred to as models. In addition, machine learning will be simply referred to as learning.

The learning control device 20 is configured to control the computing device 10 to carry out learning in a learning mode. The computing device 10 may involve in parameters of objects to be updated in learning and other parameters out of objects to be updated in learning. After setting parameter values out of objects to be updated in learning, the learning control device 20 may control the computing device 10 to carry out learning. Alternatively, the learning control device 20 may control the computing device 10 to carry out learning using parameter values while changing parameter values out of objects to be updated in learning. Subsequently, the learning control device 20 may determine parameter values out of objects to be updated in learning based on learning results.

The reservoir computing system has intermediate nodes whose values can be expressed by Equation (1).

$$\begin{matrix}[ Math . 1 ] & \\ x ( t ) = f ( {W}^{res} x ( t - 1 ) + {W}^{in} u ( t ) ) & ( 1 )\end{matrix}$$

In the above, symbols t, t−1 represent timestep indexes, i.e. time. Time t−1 means a timestep time one moment before (or previous to) time t. In the reservoir computing, output nodes are configured to update their values for each timestep since input nodes are configured to acquire input values for each timestep. In this connection, values of output nodes correspond to output values from a reservoir computing system.

The expression x(t) represents a vector representing a value of an intermediate node at time t. In the reservoir computing system, an intermediate node is correlated to an element of the vector x(t) in a one-to-one correspondence manner. The vector x(t) is expressed by a column vector.

The middle layer of reservoir computing will be referred to as a reservoir layer. The intermediate node of reservoir computing will be referred to as a reservoir node.

The symbol W^{res} represents a matrix of weight factors used for weighting values of intermediate nodes. In Equation (1), an expression “W^{res}x(t−1)” represents weighting of a value of an intermediate node at time t−1. The matrix W^{res} is a square matrix with the number of rows and the number of columns each equal to the number of elements of the vector x(t). The calculation result of “W^{res}x(t−1)” can be expressed by a column vector having the number of elements equal to the number of elements of the vector x(t).

The symbol u(t) is a vector representing a value of an input node at time t. Therefore, the vector u(t) represents an input value of the reservoir computing system at time t. The vector u(t) can be expressed by a column vector.

The symbol Wⁱⁿ is a matrix representing a weight factor for weighting a value of an input node. In Equation (1), the expression “Wⁱⁿu(t)” represents weighting of a value of an input node at time t. The matrix Wⁱⁿ has the same number of rows as the number of elements of the vector x(t) and the same number of columns as the number of elements of the vector u(t). The calculation result of “Wⁱⁿu(t)” can be expressed by a column vector having the same number of elements as the number of elements of the vector x(t).

The symbol f represents an activation function. In Equation (1), the calculation result of “W^{res}x(t−1)+Wⁱⁿu(t)” can be represented by a column vector having the same number of elements as the number of elements of the vector x(t), and therefore “f (W^{res}x(t−1)+Wⁱⁿu(t))” means that the activation function is applied to each element in the column vector.

In Equation (1), each of “W^{res}x(t−1)” and “Wⁱⁿu(t)” means a multiplication between a weight factor indicated by each element of the matrix and a value of a node indicated by each element of the vector. In this connection, it is assumed that the number of intermediate nodes would be larger than the number of input nodes, in particular, it is assumed that the expression “W^{res}x(t−1)” has a larger number of multiplications.

Multiplication needs to carry out complex processes than addition or subtraction since one-time multiplication needs to repeatedly carry out additions. For this reason, a device carrying out multiplication needs a larger consumption of power than other devices carrying out addition or subtraction. In addition, it is assumed that a multiplier implemented by hardware needs a relatively large scale of hardware, which may hinder miniaturization of devices and increase costs for producing devices.

In contrast, the computing device 10 achieves a calculation of values of intermediate nodes with a smaller number of times to carry out multiplication than the calculation of Equation (1). Due to simplification of calculations, it is expected that the computing device 10 can increase its processing speed. Due to a smaller number of times to carry out multiplication, it is possible to decrease the power consumption of the computing device 10, and therefore it is expected that the computing device 10 can be located at any place not anticipating sufficient power supply such as the vicinity of positions to locate sensors. Due to miniaturization of the computing device 10, it is expected that it is possible to increase the number of places which can locate the computing device 10. Due to inexpensive cost for producing the computing device 10, it is possible to locate a large number of computing devices 10 in distributed deployment such as edge computing with comparative ease.

The computing device 10 is configured to calculate a value of an intermediate node according to Equation (2).

$$\begin{matrix}[ Math . 2 ] & \\ x ( t ) = f ( {2}^{Z} T x ( t - 1 ) + {W}^{in} u ( t ) ) & ( 2 )\end{matrix}$$

In the above, the symbol Z represents an integer.

The symbol T represents a matrix with its elements which may have an arbitrary value of 1, 0, or −1. The matrix T has the number of rows and the number of columns, both of which are equal to the number of elements in the vector x(t). That is, both the number of rows and the number of columns in the matrix T are identical to the number of intermediate nodes in a machine-learning model of the computing device 10.

It is possible to construe that the matrix T may represent the relationship for connecting intermediate nodes. It is possible to construe that the value “1” set to an element of the matrix T indicates a connection established between intermediate nodes having a capacity of transmitting information therebetween. It is possible to construe that the value “0” set to an element of the matrix T indicates a disconnection between intermediate nodes having no capacity of transmitting information therebetween. It is possible to construe that a value “−1” set to an element of the matrix T indicates a connection established between intermediate nodes having a capacity of transmitting information therebetween, wherein the transmitted information will be multiplied by a weight factor of −1.

In this connection, the matrix will be referred to as an interconnectivity-representation matrix.

Comparing Equation (2) with Equation (1), the term “W^{res}x(t−1)” of Equation (1) is replaced with “2^{Z}tX(t−1)” in Equation (2). As to other terms, Equation (2) is identical to Equation (1).

The calculation result of “Tx(t−1)” can be expressed by a column vector having the same number of elements as the number of elements in the vector x(t). When a number-i element of a vector is expressed as < >i while an element at row i, column i of a matrix is expressed as < >i,j, it is possible to express the number-i element of a vector according to the calculation result of “Tx(t−1)” by Equation (3).

$$\begin{matrix}[ Math . 3 ] & \\ {〈 Tx ( t - 1 ) 〉}_{i} = {\sum }_{j} ( {〈 T 〉}_{i , j} {〈 x ( t - 1 ) 〉}_{j} ) & ( 3 )\end{matrix}$$

Since an element <T>i,j of the matrix T may have any one of values 1, 0, and −1, the calculation of Equation (3) needs to carry out any one of processes expressed as “ADD”, “Subtract”, and “Non-Operation” with respect to each element <x(t−1)>j of a vector x(t−1). Therefore, it is possible to carry out the calculation of Equation (3) solely using adders without needing any multipliers.

Since the symbol Z is an integer as described above, it is possible to carry out multiplication between elements of column vectors, corresponding to the calculation results of 2^{Z} and “Tx(t−1)” in the calculation of “22 Tx(t−1)”, by way of bit-string shifting.

Therefore, it is possible to carry out the calculation of “22 Tx(t−1)” using adders and shift registers, not needing any multipliers.

The calculation of Equation (3) will be explained by way of examples.

The following descriptions refer to an example using a value of the vector x(t−1), a value of the matrix T, and the integer Z which are expressed by Equation (4).

$$\begin{matrix}[ Math . 4 ] & \\ x ( t - 1 ) = ( \begin{matrix}4 \\ 3 \\ 7\end{matrix} ) , T = ( \begin{matrix}- 1 & 0 & 1 \\ 0 & 0 & - 1 \\ 0 & - 1 & - 1\end{matrix} ) , and Z = 1 & ( 4 )\end{matrix}$$

In this case, it is possible to carry out the calculation of “Tx(t−1)” by Equation (5) using addition and subtraction.

$$\begin{matrix}[ Math . 5 ] & \\ Tx ( t - 1 ) = ( \begin{matrix}- 1 & 0 & 1 \\ 0 & 0 & - 1 \\ 0 & - 1 & - 1\end{matrix} ) ( \begin{matrix}4 \\ 3 \\ 7\end{matrix} ) = ( \begin{matrix}- 4 + 0 + 7 \\ 0 + 0 - 7 \\ 0 - 3 - 1\end{matrix} ) = ( \begin{matrix}3 \\ - 7 \\ - 4\end{matrix} ) & ( 5 )\end{matrix}$$

In addition, it is possible to achieve multiplication between the calculation results of 2^{Z} and “Tx(t−1)” using shift operations by Equation (6).

$$\begin{matrix}[ Math . 6 ] & \\ {2}^{Z} Tx ( t - 1 ) = {2}^{1} ( \begin{matrix}3 \\ - 4 \\ - 7\end{matrix} ) = {2}^{1} ( \begin{matrix}00011 \\ 11001 \\ 11100\end{matrix} ) = ( \begin{matrix}00110 \\ 10010 \\ 11000\end{matrix} ) & ( 6 )\end{matrix}$$

In an example of Equation (6), it is possible to achieve multiplication of 2¹ by one-bit shifting of each bit string in binary notation leftwards (i.e. in a direction to carry over digits) with respect to each of elements “3”, “−7”, and “−4” of a column vector corresponding to the calculation results of “Tx(t−1)”.

In this connection, Equation (6) expresses a negative value using two's complement.

Aa to the activation function f of Equation (1), the activation function used for reservoir computing is not necessarily limited to a specific function, for example, wherein the activation function may employ a complex function such as a tangent hyperbolic function. As drawbacks of using a complex function as the activation function, it is possible to mention an increasing amount of power consumed by each device, a relatively large scale of hardware implementing the activation function, a hindrance to miniaturize each device, and a high cost for producing each device.

The activation function used for the computing device 10 (i.e. the function f of Equation (2)) is not necessarily limited to a specific function, for example, wherein the activation function may employ a polynomial function poly as expressed by Equation (7).

$$\begin{matrix}[ Math . 7 ] & \\ poly ( x ) = ax + {bx}^{3} & ( 7 )\end{matrix}$$

In the above, both the symbols a, b are real constants.

The polynomial function poly shows an example of a third-order polynomial function using a third-order term and a first-order term. In an attempt to conduct experiments using the polynomial function poly as the activation function of the computing device 10, it is possible to produce preferable results.

When using the polynomial function poly as the activation function, it is possible to express Equation (2) as Equation (8).

$$\begin{matrix}[ Math . 8 ] & \\ x ( t ) = poly ( {2}^{Z} T x ( t - 1 ) + {W}^{in} u ( t ) ) & ( 8 )\end{matrix}$$

When the computing device 10 uses a relatively simple function such as the polynomial function poly as the activation function, it is expected that the computing device 10 can achieve relatively high processing speed. Due to relatively small processing loads of the computing device 10 causing a relatively small amount of power consumed by the computing device 10, it is expected that the computing device 10 can be located at any place not anticipating sufficient power supply such as the vicinity of positions to locate sensors. Due to miniaturization of the computing device 10, it is expected to increase the number of positions able to locate the computing device 10. Due to a relatively simple configuration of the computing device 10 causing relatively inexpensive cost for producing the computing device 10, it is expected that many computing devices 10 can be located in distributed deployment such as edge computing with comparative ease.

In addition, the computing device 10 is configured to calculate its own output value at time t by Equation (9).

$$\begin{matrix}[ Math . 9 ] & \\ y ( t ) = {W}^{out} x ( t ) & ( 9 )\end{matrix}$$

In the above, the symbol y(t) means a value of an output node of a machine-learning model in the computing device 10 at time t. The computing device 10 is configured to output a value to be set by an output node.

The symbol W^{out} is a matrix representing weight factors for weighting values to be transmitted from intermediate nodes to output nodes. The matrix W^{out} has a number of rows identical to the number of elements of the vector y(t) and a number of columns identical to the number of elements of the vector x(t). The expression “W^{out}x(t)” represents the weighted addition to add up values of intermediate nodes for each output node at time t.

The machine-learning model of the reservoir computing can be expressed by Equation (1) and Equation (9). In the reservoir computing, it is possible to update values of the matrix W^{out} of Equation (9) by learning.

The machine-learning model of the computing device 10 can be used as one type of reservoir computing. In this connection, it is possible to construe that the machine-learning model of the computing device 10 expressed by Equation (2) and Equation (9) can be produced from the machine-learning model of reservoir computing expressed by Equation (1) and Equation (9) by substituting “2^{Z}Tx(t−1)” for “W^{res}x(t−1)” in Equation (1).

FIG. 2 is a block diagram showing a configuration example of the computing device 10. In the configuration shown in FIG. 2, the computing device 10 includes an input-value weighting unit 11, a matrix-product calculating unit 12, a shift-operation unit 13, a summation unit 14, an activation-function applying unit 15, an output-value calculating unit 16, and an intermediate-node-value storage unit 17.

The input-value weighting unit 11 is configured to obtain an input value to the computing device 10 for each timestep and to thereby weight the input value. The input-value weighting unit 11 carries out its process equivalent to an example of the calculation “Wⁱⁿu(t)” in Equation (2).

The input-value weighting unit 11 may output its weighting result to the summation unit 14. The input-value weighting unit 11 can be made up of a plurality of multipliers and a plurality of adders. The computing device 10 may handle numeric values each expressed as a bit string having a fixed length. For example, it is possible for the computing device 10 to handle numeric values expressed in a sixteen-digits fixed-point binary notation.

The matrix-product calculating unit 12 is configured to calculate a product between an interconnectivity-representation matrix and a vector representing values of intermediate nodes. As described above, the interconnectivity-representation matrix includes a plurality of elements having arbitrary values set to 1, 0, or −1. The matrix-product calculating unit 12 carries out its process equivalent to an example of the calculation “Tx(t−1)” in Equation (2).

The matrix-product calculating unit 12 may output its calculation result of the product to the shift-operation unit 13. The matrix-product calculating unit 12 can be made up of the same number of adders as the number of intermediate nodes.

The matrix-product calculating unit 12 may be an exemplary example of a matrix-product calculating means.

The shift-operation unit 13 is configured to carry out a shift operation for each element of a vector obtained by the product of the matrix-product calculating unit 12 with respect to a bit string corresponding to each value in binary notation. The shift-operation unit 13 carries out its process equivalent to a process of multiplying “2^{Z}” and “Tx(t−1)” in Equation (2).

The shift-operation unit 13 may output the result of shift operations to the summation unit 14. The shift-operation unit 13 can be made up of the same number of shift registers as the number of intermediate nodes.

The shift-operation unit 13 may be an exemplary example of a shift-operation means.

The summation unit 14 is configured to sum up a vector obtained by shift operations carried out by the shift-operation unit 13 and an input-value vector weighted by the input-value weighting unit 11. The summation unit 14 carries out its process equivalent to a calculation example of adding up “2^{Z}Tx(t−1)” and “Wⁱⁿu(t)” in Equation (2).

The summation unit 14 may output its summation result to the activation-function applying unit 15. The summation unit 14 can be made up of a single adder.

The summation unit 14 may be an exemplary example of a summation means.

The activation-function applying unit 15 is configured to apply a function determined as an activation function for each element of a vector obtained by the summation carried out by the summation unit 14, thus producing a vector representing values of intermediate nodes updated in timestep progression. The activation-function applying unit 15 carries out its process equivalent to an example of a process for calculating “x(t)” by inputting the calculation result of “2^{Z}Tx(t−1)+Wⁱⁿu(t)” of Equation (2) into the function f.

As described above, the activation-function applying unit 15 may employ a third-order polynomial function using a third-order term and a first-order term as its activation function. Specifically, the activation-function applying unit 15 may use the polynomial function poly expressed by Equation (7) as the activation function.

The activation-function applying unit 15 calculates and outputs a vector to the output-value calculating unit 16. When the activation-function applying unit 15 uses the polynomial function poly as the activation function, the activation-function applying unit 15 can be made up of a single multiplier for calculating a third-order term, a single multiplier for calculating a first-order term, and a single adder for adding up the third-order term and the first-order term.

The activation-function applying unit 15 may be an exemplary example of an activation-function applying means.

The output-value calculating unit 16 is configured to weight the updated values of intermediate nodes and to thereby produce its output values. The output-value calculating unit 16 carries out its process equivalent to an example of the calculation of “y(t)=W^{out}x(t)” in Equation (9).

The output-value calculating unit 16 produces its calculation result which can be used as an output value of the computing device 10. The output-value calculating unit 16 can be made up of a plurality of multipliers and a plurality of adders.

The output-value calculating unit 16 may be an exemplary example of an output-value calculating means.

The intermediate-node-value storage unit 17 is configured to store values of intermediate nodes calculated by the activation-function applying unit 15 in a timestep of time t. The stored values of the intermediate-node-value storage unit 17 are output to the matrix-product calculating unit 12. A process for outputting values from the intermediate-node-value storage unit 17 to the matrix-product calculating unit 12 can be construed as an example of using the value of “x(t)” resulting from the calculation of Equation (2) as the value of “x(t−1)” for the calculation of Equation (2) in the next timestep.

The intermediate-node-value storage unit 17 can be made up of a plurality of D-FFs (D-type flipflops) the number of which is identical to a product calculated between the number of intermediate nodes and the number of bits for each intermediate node.

The computing device 10 can be made up of FPGAs (Field Programmable Gate Arrays), ASICs (Application Specific Integrated Circuits), or combinations thereof. In particular, at least the matrix-product calculating unit 12 or the activation-function applying unit 15 can be made up of FPGAs, ASICs, or combinations thereof.

Due to implementation of the matrix-product calculating unit 12 or the activation-function applying unit 15 in hardware, it is expected to realize relatively high processing speed of the computing device 10, a relatively small amount of power consumed by the computing device 10, a relatively small size of the computing device 10, a relatively inexpensive cost for producing the computing device, or combinations of those effects.

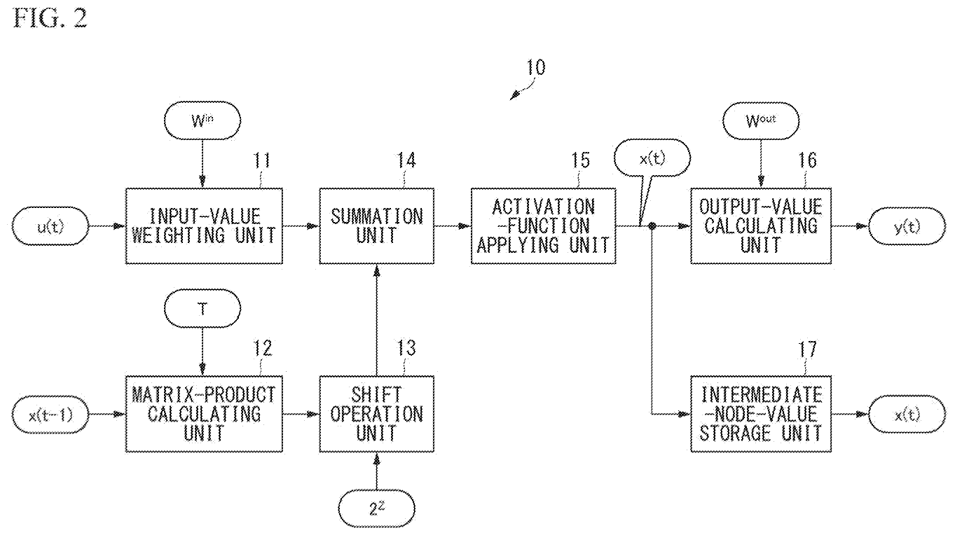

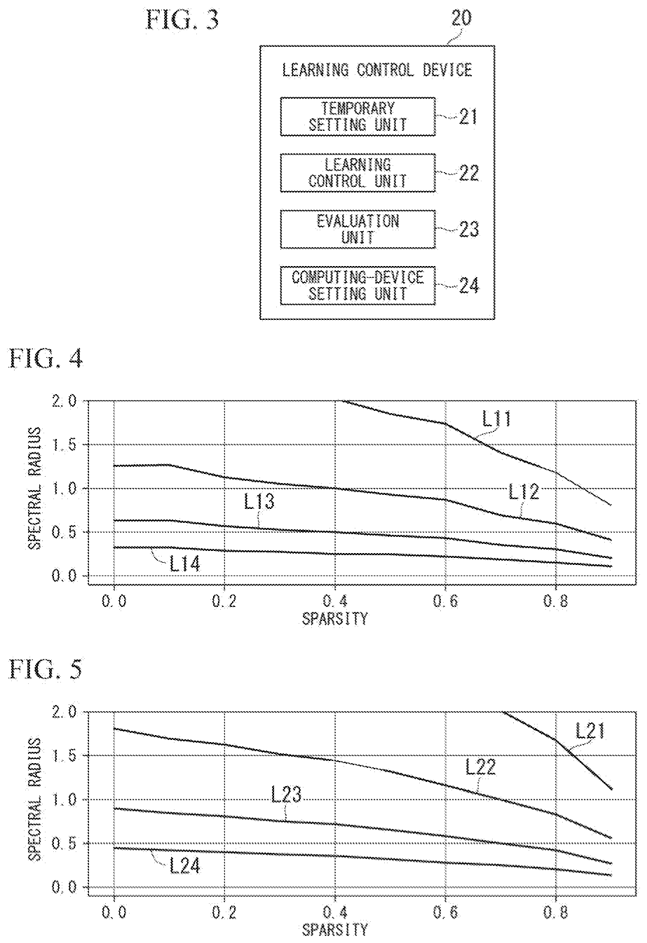

FIG. 3 shows a configuration example of the learning control device 20. In the configuration shown in FIG. 3, the learning control device 20 includes a temporary setting unit 21, a learning control unit 22, an evaluation unit 23, and a computing-device setting unit 24.

The temporary setting unit 21 is configured to temporarily set hyperparameter values for machine-learning models in the computing device 10. Herein, hyperparameters are parameters other than parameters subjected to learning among parameters of machine-learning models. The parameters subjected to learning are parameters to be updated in values by way of learning.

When the computing device 10 is used for reservoir computing, parameters subjected to learning may be weight factors (i.e. the matrix W^{out} of Equation (9)) used for weighting values to be transmitted from intermediate nodes to output nodes. The other parameters will be treated as hyperparameters. Therefore, the interconnectivity-representation matrix and an exponent of power of two (i.e. the matrix T and the integer Z of Equation (2)) can be treated as hyperparameters. In addition, weight factors (i.e. the matrix Wⁱⁿ of Equation (2)) for weighting values of input nodes can be treated as hyperparameters. When the polynomial function poly is used for the activation function f, coefficients a, b of Equation (8) can be treated as hyperparameters.

The temporary setting unit 21 may be an exemplary example of a temporary setting means.

When the temporary setting unit 21 temporarily sets values of elements in the matrix T (i.e. the interconnectivity-representation matrix), it is possible to set values of elements to zeros with a predetermined probability. The probability for which each value for each element of the matrix T becomes zero will be referred to as a sparsity expressed by a symbol “s”. For example, the temporary setting unit 21 is configured to determine values of elements of the matrix T such that, in the matrix T, values of elements will become “0” with a probability of the sparsity s, values of elements will become “1” with a probability of (1−s)/2, values of elements will become “−1” with a probability of (1−s)/2.

In this connection, a user may set the value of the sparsity s, or the temporary setting unit 21 may set or temporarily set the value of the sparsity s.

As one index value representing an accuracy of processing in the reservoir computing, it is possible to mention a spectral radius. The spectral radius can be calculated as a maximum value of an eigenvalue of a matrix. In the case of the computing device 10, it is possible to calculate a maximum value of an eigenvalue of a matrix expressed by “2″T” as a spectral radius, wherein the sparsity and the value of Z may affect the spectral radius.

FIG. 4 is a graph showing a first example of the relationship between the spectral radius and the sparsity of a machine-learning model. FIG. 4 shows an example in which the number of intermediate nodes is one-hundred. In the graph of FIG. 4, the horizontal axis represents the sparsity while the vertical axis represents the spectral radius.

A line L11 indicates the relationship between the sparsity and the spectral radius according to Equation (2) where the value of Z is zero. A line L12 indicates the relationship between the sparsity and the spectral radius when the value of Z is 1. A line L13 indicates the relationship between the sparsity and the spectral radius when the value of Z is 2. A line L14 indicates the relationship between the sparsity and the spectral radius when the value of Z is 3.

Any of the lines L11 through L14 demonstrate the spectral radius to be monotonously decreased as the sparsity is increased. Considering this tendency, it is possible to adjust the spectral radius by adjusting the sparsity.

Comparing the lines L11, L12, L13, and L14, it can be said that the spectral radius decreases as the value of Z increases. Considering this tendency, it is possible to adjust the spectral radius by adjusting the value of Z when simply adjusting the sparsity is insufficient to adjust the spectral radius.

FIG. 5 is a graph showing a second example of the relationship between the spectral radius and the sparsity of a machine-learning mode of the computing device 10. FIG. 5 shows an example in which the number of intermediate nodes is two-hundreds. In the graph of FIG. 5, the horizontal axis represents the sparsity while the vertical axis represents the spectral radius.

A line L21 indicates the relationship between the sparsity and the spectral radius according to Equation (2) where the value of Z is zero. A line L22 indicates the relationship between the sparsity and the spectral radius when the value of Z is 1. A line L23 indicates the relationship between the sparsity and the spectral radius when the value of Z is 2. A line L24 indicates the relationship between the sparsity and the spectral radius when the value of Z is 3.

Any of the lines L21 through L24 demonstrates the spectral radius to be monotonously decreased as the sparsity is increased. Accordingly, it is possible to adjust the spectral radius by adjusting the sparsity.

Comparing the lines L21, L22, L23, and L24, it can be said that the spectral radius decreases as the value of Z increases. Accordingly, it is possible to adjust the spectral radius by adjusting the value of Z when simply adjusting the sparsity is insufficient to adjust the spectral radius.

As described above, it is expected that the spectral radius can be adjusted by adjusting the sparsity and the value of Z irrespective of the number of intermediate nodes. Since the temporary setting unit 21 is configured to set values of elements of an interconnectivity-representation matrix (i.e. the matrix T) based on the sparsity, a user or the computing device 10 can adjust the spectral radius with comparative ease.

A parameter used for the processing of the learning control device 20 such as the sparsity s will be simply referred to as a parameter of the learning control device 20.

The learning control unit 22 may control the computing device 10, having a setting of hyperparameter values such as values of elements of an interconnectivity-representation matrix, to carry out learning, thus updating a weight factor (e.g. a value of the matrix W^{out}), which the computing device 10 may use to calculate its output value.

The learning control unit 22 may be an exemplary example of a learning control means.

The evaluation unit 23 is configured to evaluate the learning result of the computing device 10.

The computing-device setting unit 24 is configured to set up the computing device 10 based on the learning result of the computing device 10.

The temporary setting unit 21 may make settings of hyperparameters in multiple ways such that the learning control unit 22 can control the computing device 10 to carry out learning for each setting of hyperparameter values. Subsequently, the evaluation unit 23 may evaluate the learning result for each setting of hyperparameters, and therefore the computing-device setting unit 24 may set to the computing device 10 the hyperparameter values with the highest evaluation result of the learning result. Accordingly, it is expected that it is possible to set hyperparameter values to improve the accuracy of the processing of the computing device 10.

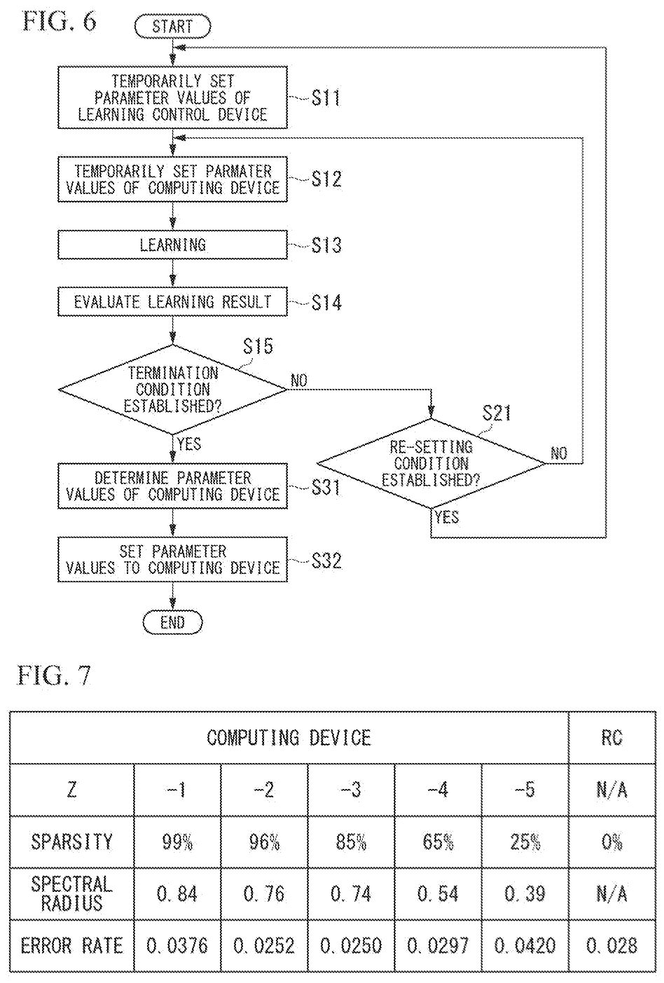

FIG. 6 is a flowchart showing an example of the procedure of the learning control device 20.

According to the procedure of FIG. 6, the temporary setting unit 21 temporarily sets parameter values of the learning control device 20 (step S11). In particular, the learning control device 20 may temporarily set the value of the sparsity s.

Next, the temporary setting unit 21 temporarily sets parameter values of the computing device 10 (step S12). Specifically, the temporary setting unit 21 may temporarily set hyperparameter values of the computing device 10, thus initializing parameter values subjected to learning. The temporary setting unit 21 sets values of elements of the interconnectivity-representation matrix T based on the value of the sparsity s.

Next, the learning control unit 22 controls the computing device 10 to carry out learning (step S13). The learning control unit 22 may update values of elements of the matrix W^{out}, serving as parameters subjected to learning, by way of learning.

Next, the evaluation unit 23 evaluates the learning result (step S14). When the computing device 10 makes a classification, for example, the evaluation unit 23 may evaluate an accuracy of classification by the computing device 10 after learning.

Next, the learning control unit 22 determines whether or not a termination condition is established with learning (step S15). The condition used for determination of the learning control unit 22 is not necessarily limited to a specific condition. For example, the learning control unit 22 may determine whether or not the number of times to make learning is above a predetermined number of times. Alternatively, the learning control unit 22 may determine whether or not the learning result of the evaluation unit 23 has obtained an evaluation value above a predetermined value.

When the learning control unit 22 determines that the termination condition of learning fails to be established (step S15: NO), the temporary setting unit 21 determines whether not a re-setting condition has been established with respect to parameter values of the learning control device 20 (step S21). The condition for determination of the temporary setting unit 21 may be a condition as to whether learning has been made using the set parameter values a predetermined number of times or more: but this is not a restriction.

When the temporary setting unit 21 determines that the re-setting condition fails to be established (step S21: NO), a flow will return to step S12. In this case, the temporary setting unit 21 does not change the parameter values of the learning control device 20, while the temporary setting unit 21 may change the parameter values of the computing device 10 by temporarily setting the parameter values of the computing device 10 again in step S12.

When the temporary setting unit 21 determines that the re-setting condition is successfully established (step S21: YES), a flow will return to step S11. In this case, the temporary setting unit 21 may change the parameter values of the learning control device 20 by temporarily setting the parameter values of the learning control device 20 again in step S11.

On the other hand, when the learning control unit 22 determines that the termination condition of learning is successfully established (step S15: YES), the computing-device setting unit 24 determines the parameter values of the computing device 10 (step S31). For example, the computing-device setting unit 24 may select the learning having the highest evaluation made by the evaluation unit 23. Subsequently, the computing-device setting unit 24 may determine the parameter values of the computing device 10 at the time of terminating the selected learning as the parameter values set to the computing device 10.

Thereafter, the computing-device setting unit 24 determines and sets the parameter values to the computing device 10.

After step S32, the learning control device 20 exits the procedure of FIG. 6.

FIG. 7 is a table showing an example of the relationship between a sparsity and an evaluation accuracy of the computing device 10. FIG. 7 shows the results of experiments using NARMA 10 as benchmarks.

In experiments, the computing device 10 inputted time-series data until time t−1 and estimated data values at time t.

According to NARMA10 (where NARMA stands for Nonlinear Autoregressive Moving Average), 2,000 steps of time-series data were used for the learning of the computing device 10 while other 3,000 steps other than 2,000 steps used for learning were used to test an evaluation accuracy of the computing device 10. In this connection, first 200 steps among time-series data of NARMA10 were deleted to prevent an impact due to initial states of intermediate nodes. In addition, a normalized mean-squared error (NMSE) was calculated as an error rate.

FIG. 7 shows error rates and spectral radiuses for each setting of the integer Z and the sparsity s. In addition, FIG. 7 shows the results of experiments which were conducted using a general reservoir computing system.

An example of FIG. 7 demonstrates how the spectral radius is adjusted by adjusting the value of the integer Z and the sparsity s. In addition, the error rate will be changed responsive to the spectral radius. In particular, the error rate was diminished at the spectral radiuses of 0.76 and 0.74, indicating smaller error rates than those obtained by the general reservoir computing.

As described above, the matrix-product calculating unit 12 is configured to calculate a product between a vector representing values of intermediate nodes and an interconnectivity-representation serving as a matrix having a plurality of elements having values set to 1, 0, or −1. The shift-operation unit 13 is configured to carry out a shift operation of a bit string for each element in binary notation among elements of a vector which can be obtained from the product between the interconnectivity-representation matrix and the vector representing values of intermediate nodes. The summation unit 14 is configured to add a vector produced by the shift operation and a vector having the weighted input values together. The activation-function applying unit 15 is configured to apply a function, which is determined as an activation function, for each element among elements of a vector which is obtained by way of summation of the vector obtained by the shift operation and the vector having the weighted input values, thus calculating a vector representing the values of intermediate nodes updated according to timestep progression. The output-value calculating unit 16 is configured to calculate output values by weighting the updated values of intermediate nodes.

According to the computing device 10, it is possible to carry out computation of a computational model having a recurrent network architecture with comparative ease. In particular, it is possible for the computing device 10 to carry out computation of a computational model having a recurrent network architecture according to Equation (2). The calculation of “2^{Z}Tx(t−1)” of Equation (2) can be carried out using an adder and a shift register without needing any multiplier.

In addition, the activation-function applying unit 15 uses a third-order polynomial function having a third-order term and a first-order term as the activation function.

According to the activation-function applying unit 15, it is possible to carry out calculations of the activation function by way of calculations of relatively simple equations.

In addition, at least the matrix-product calculating unit 12 or the activation-function applying unit 15 can be configured using FPGA or ASIC.

Accordingly, due to implication of the matrix-product calculating unit 12 or the activation-function applying unit 15 in hardware, it is expected to realize relatively high processing speed of the computing device 10, a relatively small amount of power consumed by the computing device 10, a relatively small size of the computing device 10, relatively inexpensive cost for producing the computing device 10, or combinations of those effects.

In addition, the temporary setting unit 21 of the learning control device 20 is configured to set values of elements of an interconnectivity-representation matrix in the computing device 10 such that each element will be set to zero with a predetermined probability. The learning control unit 22 may control the computing device 10, having a setting of values of elements of the interconnectivity-representation matrix, to carry out learning, thus updating weight factors for calculating output values.

According to the learning control unit 22, it is possible to adjust the spectral radius by way of a simple method for setting the value of a sparsity representing a probability for which each value for each element of an interconnectivity-representation matrix becomes zero, and the value of the integer Z representing an exponent of power of two. It is expected to improve the accuracy of processing of the computing device 10 by adjusting the spectral radius.

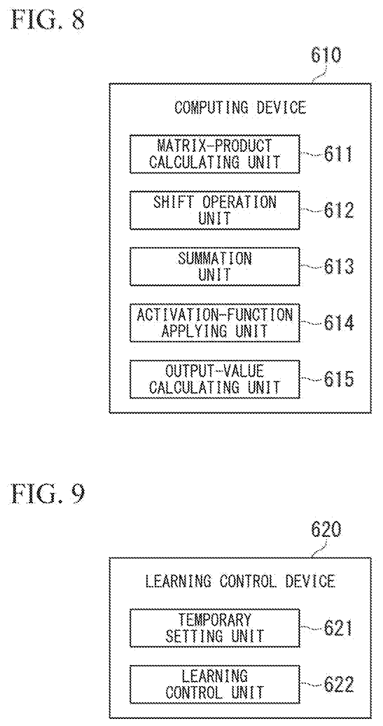

FIG. 8 is a block diagram showing another configuration example of the computing device according to the exemplary embodiment. In the configuration shown in FIG. 8, a computing device 610 includes a matrix-product calculation unit 611, a shift operation unit 612, a summation unit 513, an activation-function applying unit 614, and an output-value calculating unit 615.

In this configuration, the matrix-product calculating unit 611 is configured to calculate a product between an interconnectivity-representation matrix, i.e. a matrix having a plurality of elements each having a value of 1, 0, or −1, and a vector representing values of intermediate nodes. The shift operation unit 612 is configured to carry out a shift operation with a bit string in binary notation for each element among elements of a vector which is obtained according to the product calculated between the interconnectivity-representation matrix and the vector representing values of intermediate nodes. The summation unit 613 is configured to add the vector obtained by the shift operation and a vector having the weighted input values. The activation-function applying unit 614 is configured to apply a function, which is determined as an activation function, for each element among elements of a vector obtained by way of summation of the vector obtained by the shift operation and the vector having the weighted input values, thus calculating a vector representing the values of intermediate nodes updated in timestep progression. The output-value calculating unit 615 is configured to calculate output values by weighting the updated values of intermediate nodes.

The matrix-product calculating unit 611 may be an exemplary example of a matrix-product calculating means. The shift operation unit 612 may be an exemplary example of a shift operation means. The summation unit 614 may be an exemplary example of a summation means. The activation-function applying unit 614 may be an exemplary example of an activation-function applying means. The output-value calculating unit 615 may be an exemplary example of an output-value calculating means.

According to the computing device 610, it is possible to carry out calculations of a computational model having a recurrent network architecture with comparative ease. In particular, it is possible for the computing device 610 to carry out calculations of a computational model having a recurrent network architecture by means of the matrix-product calculation unit 611, the shift operation unit 612, the summation unit 613, and the activation-function applying unit 614. The matrix-product calculating unit 611 may be configured of adders without needing any multipliers. The shift operation unit 612 may be configured of shift registers without needing any multipliers.

FIG. 9 is a block diagram showing another configuration example of the learning control device according to the exemplary embodiment. In the configuration shown in FIG. 9, a learning control device 620 includes a temporary setting unit 621 and a learning control unit 622.

In this configuration, the temporary setting unit 612 is configured to set values of elements of an interconnectivity-representation matrix in a computing device such that the value for each element will be set to zero with a predetermined probability. The interconnectivity-representation matrix is a matrix having a plurality of elements having values each set to 0, 1, or −1. The computing device includes a matrix-product calculating unit, a shift operation unit, a summation unit, an activation-function applying unit, and an output-value calculating unit. The matrix-product calculating unit is configured to calculate a product between an interconnectivity-representation matrix and a vector representing values of intermediate nodes. The shift operation unit is configured to carry out a shift operation with a bit string in binary notation for each element among elements of a vector obtained according to the product calculated between the interconnectivity-representation matrix and the matrix representing values of intermediate nodes. The summation unit is configured to add a vector obtained by the shift operation and a vector having the weighted input values. The activation-function applying unit is configured to apply a function, which is determined as an activation function, for each element among elements of a vector obtained by way of summation of the vector obtained by the shift operation and the vector having the weighted input values, thus calculating a vector representing values of intermediate nodes updated in timestep progression. The output-value calculating unit is configured to calculate output values by weighting the updated values of intermediate nodes.

The learning control unit 622 control the computing device having a setting of values of elements of an interconnectivity-representation matrix to carry out learning, thus updating weight factors used to calculate output values.

The temporary setting unit 621 may be an exemplary example of a temporary setting means. The learning control unit 622 may be an exemplary example of a learning control means.

According to the learning control device 620, it is possible to adjust the spectral radius in a machine-learning model of a computing device by setting a probability for which each value for each element of an interconnectivity-representation matrix becomes zero. Due to adjustment of the spectral radius, it is expected to improve the accuracy of processing of a computing device.

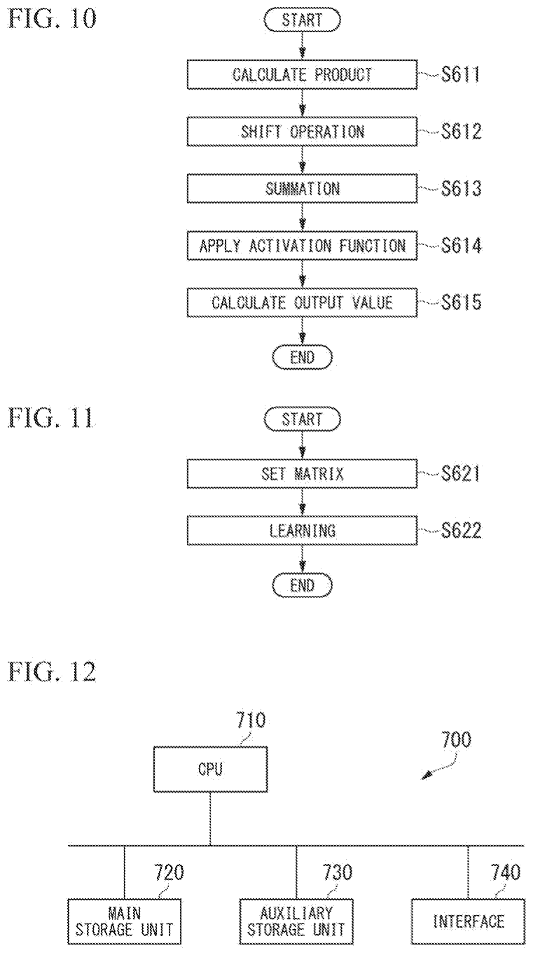

FIG. 10 is a flowchart showing an example of a procedure according to a computing method of the exemplary embodiment. The computing method shown in FIG. 10 includes a series of steps for calculating a product (step S611), carrying out a shift operation (step S612), making summation (step S613), applying an activation function (step S614), and calculating output values (step S615). The step for calculating a product (step S611) is configured to calculate a product between an interconnectivity-representation matrix serving as a matrix including a plurality of elements having values each set to 1, 0, or −1 and a vector representing values of intermediate nodes. The step for carrying out a shift operation (S612) is configured to carry out a shift operation with a bit string in binary notation for each element among elements of a vector obtained by a product calculated between the interconnectivity-representation matrix and the vector representing values of intermediate nodes. The step for making summation (step S613) is configured to add a vector obtained by the shift operation and a vector including the weighted input values. The step for applying an activation function (step S614) is configured to apply a function, which is determined as an activation function, for each element among elements of a vector obtained by summation of the vector obtained by the shift operation and the vector having the weighted input values, thus calculating a vector representing values of intermediate nodes updated in timestep progression. The step for calculating output values (step S615) is configured to calculate output values by weighting the updated values of intermediate nodes.

According to the computing method shown in FIG. 10, it is possible to carry out calculations of a computational model having a recurrent network architecture with comparative ease. In particular, according to the computing method shown in FIG. 10, it is possible to carry out calculations of a computational model having a recurrent network architecture by way of a series of steps S611 through S614. The process of step S611 can be carried out using addition without needing multiplication. The process of step S612 can be carried out using a shift operation without needing multiplication.

FIG. 11 is a flowchart showing an example of a procedure of a learning control method according to the exemplary embodiment. The learning control method shown in FIG. 11 includes a series of steps for setting a matrix (step S621) and making learning (step S622).

The step for setting a matrix (step S621) is configured to set values of elements of an interconnectivity-representation matrix in a computing device such that each value will be set to zero with a predetermined probability. The interconnectivity-representation matrix is a matrix including a plurality of elements having values each set to 1, 0, or −1. The computing device includes a matrix-product calculating unit, a shift operation unit, a summation unit, an activation-function applying unit, and an output-value calculating unit. The matrix-product calculating unit is configured to calculate a product between an interconnectivity-representation matrix and a vector representing values of intermediate nodes. The shift operation unit is configured to carry out a shift operation with a bit string in binary notation for each element among elements of a vector obtained by the product calculated between the interconnectivity-representation matrix and the vector representing values of intermediate nodes. The summation unit is configured to add a vector obtained by the shift operation and a vector having the weighted input values. The activation-function applying unit is configured to apply a function, which is determined as an activation function, for each element among elements of a vector obtained by summation between the vector obtained by the shift operation and the vector representing the weighted input values, thus calculating a vector representing values of intermediate nodes updated in timestep progression. The output-value calculating unit is configured to calculate output values by weighting the updated values of intermediate nodes.

The step for making learning (step S622) is configured to control the computing device having a setting of values of elements of an interconnectivity-representation matrix to make learning, thus updating weight factors used for calculating output values.

According to the learning control method shown in FIG. 11, it is possible to adjust the spectral radius of a machine-learning model of a computing device by setting a probability for which each value for each element of an interconnectivity-representation matrix becomes zero. Due to adjustment of the spectral radius, it is expected to improve the accuracy of processing of a computing device.

FIG. 12 is a block diagram diagrammatically showing a computer configuration according to at least one embodiment.

In the configuration shown in FIG. 12, a computer 700 includes a CPU (Central Processing Unit) 710, a main storage unit 720, an auxiliary storage unit 730, and an interface 740.

Any one of the aforementioned computing device 10, the learning control device 20, the computing device 610, and the learning control device 620 or one or more of them can be implemented with the computer 700. In this case, programs describing operations of the aforementioned processing may be stored on the auxiliary storage unit 730. The CPU 710 may read programs from the auxiliary storage unit 730 and expand them on the main storage unit 720, thus achieving the aforementioned processing according to programs. In addition, the CPU 710 may secure storage areas corresponding to the aforementioned storage units on the main storage unit 720 according to programs. The interface 740 has a communication function to realize communication between each device and other devices by conducting communication under the control of the CP 710.

When implementing the computing device 10 with the computer 700, programs describing the aforementioned operations of the input-value weighting unit 11, the matrix-product calculating unit 12, the shift operation unit 13, the summation unit 14, the activation-function applying unit 15, and the output-value calculating unit 16 are stored on the auxiliary storage unit 730. The CPU 710 may read programs from the auxiliary storage unit 730 and expand them on the main storage unit 720, thus achieving the aforementioned processing according to programs.

In addition, the CPU 710 may secure storage areas for the processing of the computing device 10 such as the intermediate-node-value storage unit 17 on the main storage unit 720 according to programs. The interface 740 has a communication function to realize communication between the computing device 10 and other devices by conducting communication under the control of the CPU 710. An interaction between the computing device 10 and its user can be implemented upon receiving a user operation by way of the interface 740 having an input device and a display device configured to display various images under the control of the CPU 710.

When implementing the learning control device 20 with the computer 700, programs describing the aforementioned operations of the temporary setting unit 21, the learning control unit 22, the evaluation unit 23, and the computing-device setting unit 24 are stored on the auxiliary storage unit 730. The CPU 710 may read programs from the auxiliary storage unit 730 and expand them on the main storage unit 720, thus achieving the aforementioned processing according to programs.

In addition, the CPU 710 may secure storage areas for the processing of the learning control device 20 on the main storage unit 720 according to programs. The interface 740 has a communication function to realize communication between the learning control device 20 and other devices by conducting communication under the control of the CPU 710. An interaction between the learning control device 20 and its user can be implemented upon receiving a user operation by way of the interface 740 having an input device and a display device configured to display various images under the control of the CPU 710.

When implementing the computing device 610 with the computer 700, programs describing the operations of the matrix-product calculating unit 611, the shift operation unit 612, the summation unit 613, the activation-function applying unit 614, and the output-value calculating unit 615 are stored on the auxiliary storage unit 730. The CPU 710 may read programs from the auxiliary storage unit 730 and expand them on the main storage unit 720, thus achieving the aforementioned processing according to programs.

In addition, the CPU 710 may secure storage areas for the processing of the computing device 610 on the main storage unit 720 according to programs. The interface 740 has a communication function to realize communication between the computing device 610 and other devices by conducting communication under the control of the CPU 710. An interaction between the computing device 610 and its user can be implemented upon receiving a user operation by way of the interface 740 having an input device and a display device configured to display various images under the control of the CPU 710.

When implementing the learning control device 620 with the computer 700, programs describing the operations of the temporary setting unit 621 and the learning control unit 622 are stored on the auxiliary storage unit 730. The CPU 710 may read programs from the auxiliary storage unit 730 and expand them on the main storage unit 720, thus achieving the aforementioned function according to programs.

In addition, the CPU 710 may secure storage areas for the processing of the learning control device 620 on the main storage unit 720 according to programs. The interface 740 has a communication function to realize communication between the learning control device 620 and other devices by conducting communication under the control of the CPU 710. An interaction between the learning control device 620 and its user can be implemented upon receiving a user operation by way of the interface 740 having an input device and a display device configured to display various images under the control of the CPU 710.

Programs used to execute the entirety or part of the processing implemented by the computing device 10, the learning control device 20, the computing device 610, and the learning control device 620 can be stored on computer-readable storage media, thereafter, a computer system may load and execute programs stored on storage media so as to achieve the aforementioned processing. Herein, the term “computer system” includes software such as an operating system (OS) and hardware such as peripheral devices.

In addition, the term “computer-readable storage media” refers to flexible disks, magneto-optical disks, ROM (Read-Only Memory), portable media such as CD-ROM

(Compact Disk Read-Only Memory), and storage units such as hard disks embedded in computer systems. Moreover, the aforementioned programs may achieve part of the aforementioned functions, or the aforementioned programs can be combined with other programs pre-installed in computer systems to achieve the aforementioned functions.

Heretofore, an exemplary embodiment of the present invention has been described in detail with reference to the accompanying drawings, however, detailed configurations should not be limited to the exemplary embodiment: hence, the present invention may include any designs without departing from the subject matter of the invention as defined in the appended claims.

### INDUSTRIAL APPLICABILITY

The present invention is applicable to a computing device, a learning control device, a computing method, a learning control method, and a storage medium.

### REFERENCE SIGNS LIST

1 Computing system
10, 610 Computing device
11 Input-value weighting unit
12, 611 Matrix-product calculating unit
13, 612 Shift operation unit
14, 613 Summation unit
15, 614 Activation-function applying unit
16, 615 Output-value calculating unit
17 Intermediate-node-value storage unit
20, 620 Learning control device
21, 621 Temporary setting unit
22, 622 Learning control unit
23 Evaluation unit
24 Computing-device setting unit

1. A computing device comprising:
a memory configured to store instructions; and
a processor configured to execute the instructions to:
calculate a product between an interconnectivity-representation matrix including a plurality of elements having values each set to 1, 0, or −1 and a vector representing values of intermediate nodes;
to carry out a shift operation with a bit string in binary notation for each element among a plurality of elements of a vector obtained by the product;
make summation of a vector obtained by the shift operation and a vector including weighted input values;
apply a function, which is determined as an activation function, for each element among a plurality of elements of a vector obtained by the summation of the vector obtained by the shift operation and the vector having the weighted input values, thus calculating a vector representing the values of the intermediate nodes updated in timestep progression; and
calculate a plurality of output values by weighting the updated values of the intermediate nodes.

2. The computing device according to claim 1, wherein the processor is configured to execute the instructions to use a third-order polynomial function having a third-order term and a first-order term as the activation function.

3. The computing device according to claim 1, wherein the processor includes a Field Programmable Gate Array (FPGA) or an Application Specific Integrated Circuit (ASIC).

4. A learning control device comprising:
a memory configured to store instructions; and
a processor configured to execute the instructions to:
to set the plurality of elements of the interconnectivity-representation matrix of the computing device according to claim 1 such that each element has a value which becomes zero with a predetermined probability; and
control the computing device having a setting of elements of the interconnectivity-representation matrix to make learning, thus updating weight factors used for calculating the plurality of output values.

5. A computing method executed by a computing device, comprising:
calculating a product between an interconnectivity-representation matrix including a plurality of elements having values each set to 1, 0, or −1 and a vector representing values of intermediate nodes;
carrying out a shift operation with a bit string in binary notation for each element among a plurality of elements of a vector obtained by the product;
making summation of a vector obtained by the shift operation and a vector including weighted input values;
applying a function, which is determined as an activation function, for each element among a plurality of elements of a vector obtained by the summation of the vector obtained by the shift operation and the vector having the weighted input values, thus calculating a vector representing the values of the intermediate nodes updated in timestep progression; and
calculating a plurality of output values by weighting the updated values of the intermediate nodes.

6. (canceled)

7. (canceled)

8. (canceled)
